(19) United States
(12) Patent Application Publication
(10) Pub. No.: US 2002/0083437 A1
(43) Pub. Date: Jun. 27, 2002

(54) Internet-based digital promotion system

(76) Inventors: Anthony R. Fiore, Long Valley, NJ (US); James R. Klein JR., Ft. Washington, PA (US)

Correspondence Address: Michael S. Neustel, Suite No. 4, 2534 South University Drive, Fargo, ND, 58103, US

(21) Appl. No.: 09/948,230

(22) Filed: Sep. 7, 2001

Related U.S. Application Data
(60) Provisional application No. 60/231,347, filed on Sep. 8, 2000.

(51) Int. Cl. H04N 7/16; G09G 5/00

(52) U.S. Cl. 725/23; 345/700

(57) ABSTRACT

An Internet-based digital promotion system for effectively presenting interactive promotional items to consumers during a digital broadcast/transmission. The Internet-based digital promotion system includes a control center, at least one broadcast station, and at least one computer system all in communication with one another via a global computer network (e.g. Internet). A receiver in communication with the computer system of a viewer receives a digital signal transmitted by the broadcast station. The digital signal contains video, audio and digital tokens wherein the digital tokens correspond to commercials or other events occurring within the digital signal. The digital token is displayed as an object upon the display screen of the computer system or a television thereby allowing the viewer to select the object. Upon selecting the object, the file data is logged to the computer system along with the date and time. When the computer system is logged upon the Internet, the digital token information is transmitted to the control center via the Internet wherein the viewer is able to redeem coupons and other promotional items. The control center logs the consumer information relating to the viewer to assist in obtaining marketing research of the digital broadcast/transmission programming and commercials.

### CROSS REFERENCE TO RELATED APPLICATIONS

I hereby claim benefit under Title 35, United States Code, Section 119(e) of United States provisional patent application Serial No. 60/231,347 filed Sep. 8, 2000. This application is a continuation of the 60/231,347 application. The 60/231,347 application is currently pending. The 60/231,347 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to digital television broadcasts and digital transmissions (“digital broadcast/transmission”). More specifically, it relates to an Internet-based digital promotion system for effectively presenting interactive promotional items to consumers during a digital broadcast/transmission. Further the invention relates to the distribution and authorization of serialized digital tokens (“digital data”) and a method for relating specific promotions to the digital data.

Digital broadcasts/transmissions are growing rapidly with the usage of personal satellite television systems, “over-the-air” antennas, cable and the Internet. The arrival of digital television (“DTV”) to consumers within the home via televisions is one of the most significant developments in television technology. DTV has the capability to provide clearer and sharper, cinema-like pictures as well as multi-channel, CD-quality sound. DTV can also provide new uses such as multiple video programs or other services on a single television channel, including data services. The use of DTV technology will also allow the television to enter the digital world of the personal computer and the Internet.

With the proliferation of connections to the Internet by a rapidly growing number of individuals, the viability of the Internet as a widely accepted medium of communication has increased correspondingly. The Internet is comprised of a global computer network allowing various types of data to be transmitted including but not limited to video and audio. The type of connection the individual has to the Internet determines the resolution and frame rate of the video displayed upon the individual's computer monitor. With increased bandwidth of connections by individuals such as DSL, ISDN, T1, T3 and cable modems, digital broadcasts/transmissions are becoming increasingly accessible to consumers. As these broadcasts/transmissions are primarily funded through advertising, there is a need for an Internet-based digital promotion system that effectively includes advertisements to consumers without interrupting a digital presentation.

2. Description of the Prior Art

There are three main forms of transmitting and receiving a digital television broadcast/transmission—(1) digital satellite systems, (2) DTV via “over-the-air” or cable, and (3) Internet. The first and most commonly utilized form of digital television broadcast is the digital satellite system. The most common manufacturers of these satellite systems include DIRECTV and DISHNETWORK. The digital satellite system typically consists of a small satellite dish for receiving a digital satellite broadcast signal, a digital integrated receiver/decoder (IRD), which separates each channel, and decompresses and translates the digital signal so a conventional television can show it. Most digital satellite systems employ either MPEG or MPEG-2 technology (i.e. Moving Pictures Experts Group). MPEG is a technology that can compress a moving image so it requires a tiny fraction of the space it normally would for a transmission.

The second type of digital television broadcast system uses a relatively new “over-the-air” or “cable” system that will be used by numerous local broadcast stations in the United States in the near future. DTV may be comprised of two main resolution formats—High Definition Television (HDTV) and Standard Definition Television (SDTV). The DTV standard is based on the Advanced Television System Committee (ATSC). Information regarding the standards set by the ATSC can be found upon their web site at http://www.atsc.org/.

The DTV standard is a relatively flexible television system that allows broadcasters to provide new and higher quality services. The DTV system allows broadcasters to transmit multiple programs simultaneously using a single television channel. Television stations will, depending on the type and source of programming, be able to transmit multiple SDTV programs or in some cases two HDTV programs. DTV also will provide improved audio quality, similar to that of compact discs, with up to five channels of sound per program.

The new DTV system also allows for support delivery of digital data services simultaneously with television and audio programming. Using this data transmission capability, it will be possible for broadcast stations to send publications (such as a local “electronic newspaper”), program schedules, computer software, information requested about specific products, or virtually any other type of information, at the same time that they transmit regular television programming.

The third method of transmitting digital broadcasts/transmissions is via the Internet. This form of transmitting digital multimedia information has been around for years and has become conventional in the art. With the usage of high speed Internet connections, additional improvements in this area of digital television will be made.

Conventional advertisements within television have been in use for years by television broadcasters. The most common type of advertisement found within television broadcasts is the “commercial.” The conventional commercial typically is positioned one or more times within the television broadcast interrupting the sequence of the television program being watched forcing the viewer to observe the commercial and delaying the presentation of the television program.

Conventional methods of advertising within a television broadcast are simply limited and require significant interruptions of the television program. Many consumers, having endured traditional advertising are “preprogrammed” to ignore commercials that are presented within a television program and often times will perform additional activities during these unwanted commercials thereby decreasing the overall effectiveness of commercials. By providing an alternative method of advertising that combines traditional commercials with interactive promotions, advertisers' promotions reach the consumer and evoke interaction and response.

Examples of related patents include U.S. Pat. No. 5,070,404 to Bullock et al.; U.S. Pat. No. 5,969,770 to Horton; U.S. Pat. No. 5,534,942 to Beyers, Jr. et al.; U.S. Pat. No. 5,070,404 to Bullock et al.; U.S. Pat. No. 6,006,241 to Purnaveja et al; U.S. Pat. No. 5,600,775 to King et al.; U.S. Pat. No. 5,819,285 to Damico et al.; U.S. Pat. No. 6,006,197 to d'Eon et al; U.S. Pat. No. 5,933,811 to Angles et al.; U.S. Pat. No. 5,948,061 to Merriman et al.; U.S. Pat. No. 5,970,477 to Roden; U.S. Pat. No. 5,799,318 to Cardinal et al.; U.S. Pat. No. 5,924,078 to Naftzger; U.S. Pat. No. 5,970,470 to Walker et al.; U.S. Pat. No. 6,014,634 to Scroggie et al.; U.S. Pat. No. 6,041,308 to Walker et al.; U.S. Pat. No. 5,729,693 to Holda-Fleck; U.S. Pat. No. 5,761,648 to Golden et al.; U.S. Pat. No. 5,884,277 to Khosla; and U.S. Pat. No. 5,907,830 to Engel et al. are all illustrative of such prior art.

While the previous inventions disclosed within the above patents may be suitable for the particular purpose to which they address, they are not as suitable for effectively evoking interaction and a response from consumers during a digital broadcast/transmission over a global computer network. Conventional advertising methods and systems are not suitable within today's society in which interactivity and consumer response is paramount.

In these respects, the Internet-based digital promotion system according to the present invention substantially departs from the conventional concepts and designs of the prior art, and in so doing provides an apparatus primarily developed for the purpose of effectively presenting interactive promotional items to consumers during a digital broadcast/transmission.

Additionally, the present invention provides for the tracking and usage of the digital data from the time it is authorized by the control center through the embedding of the digital data into the digital broadcasts/transmission, and finally to the verification/redemption of the consumer back at the control center.

### SUMMARY OF THE INVENTION

In view of the foregoing disadvantages inherent in the known types of Internet advertising systems now present in the prior art, the present invention provides a new Internet-based digital promotion system construction wherein the same can be utilized for effectively presenting interactive promotional items to consumers during a digital broadcast/transmission.

The general purpose of the present invention, which will be described subsequently in greater detail, is to provide a new Internet-based digital promotion system that has many of the advantages of the digital broadcast/transmission systems mentioned heretofore and many novel features that result in a new Internet-based digital promotion system which is not anticipated, rendered obvious, suggested, or even implied by any of the prior art digital broadcast/transmission systems, either alone or in any combination thereof.

To attain this, the present invention generally comprises control center, at least one broadcast station, and at least one digital device (e.g. computer system, television cable receiver, etc.) all in communication with one another via a global computer network (e.g. Internet). A receiver in communication with the computer system of a viewer receives a digital signal containing a digital broadcast/transmission including commercials. The digital signal contains video, audio, digital tokens, and other information wherein the digital token corresponds to commercials or other events occurring within the digital signal. The digital token is displayed as an object upon the display screen of the computer system, a television, or other digital device, thereby allowing the viewer to select the object. Upon selecting the object, the digital token is logged to the computer system along with the date and time. When the computer system is logged upon the Internet, the file data information is transmitted to the control center via the Internet wherein the viewer is able to redeem coupons or other promotional items. The control center logs the consumer information relating to the viewer to assist in marketing research of the broadcast/transmission programming and commercials. Additionally, the control center will verify, authorize, and facilitate the process of obtaining the promotional items.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an Internet-based digital promotion system that will overcome the shortcomings of the prior art devices.

Another object of the present invention is to provide an Internet-based digital promotion system that allows for the usage of one or more remote control devices in selecting representative objects from a display.

A second object is to provide an Internet-based digital promotion system for effectively presenting interactive promotional items to consumers during a digital broadcast/transmission.

Another object is to provide an Internet-based digital promotion system that simultaneously broadcasts/transmits advertising data along with a digital broadcast/transmission.

An additional object is to provide an Internet-based digital promotion system that is interactive with an individual viewing a digital presentation.

A further object is to provide an Internet-based digital promotion system that requires the consumer to select a displayed object during a digital presentation.

Another object is to provide an Internet-based digital promotion system that can offer, track and redeem various items such as but not limited to coupons, sweepstakes, awards, cash, merchandise, discount offers, memberships, services, tickets and software.

A further object is to provide an Internet-based digital promotion system that accumulates purchasing habit data from consumers in regards to specific advertisements.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of an exemplary computer system for practicing the various aspects of the present invention.

FIG. 2 is a block diagram illustrating the communications between a digital television transmitter and receiver along with a computer system connected to a global computer network.

FIG. 3 is a block diagram illustrating the communications between a digital television transmitter and receiver along with a television connected to a global computer network.

FIG. 4 is a flowchart illustrating the request, creation and transmittal of a unique data token to be attached to digital data.

FIG. 5 is a flowchart illustrating the transmittal of a digital signal containing digital data plus the digital token.

FIG. 6 is a flowchart illustrating the uploading of logged data token to the control center.

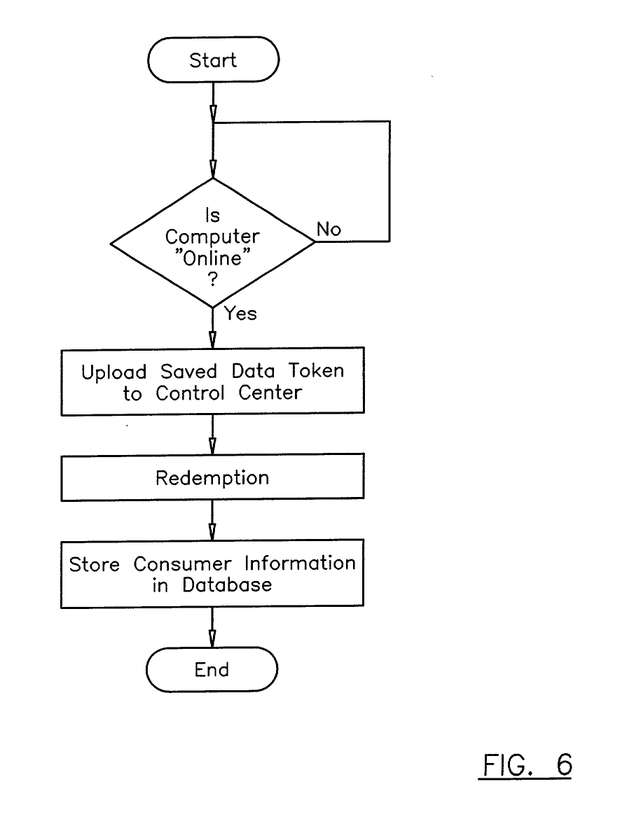

FIG. 7 is a flowchart illustrating the receipt of an uploaded data token and the redemption thereof.

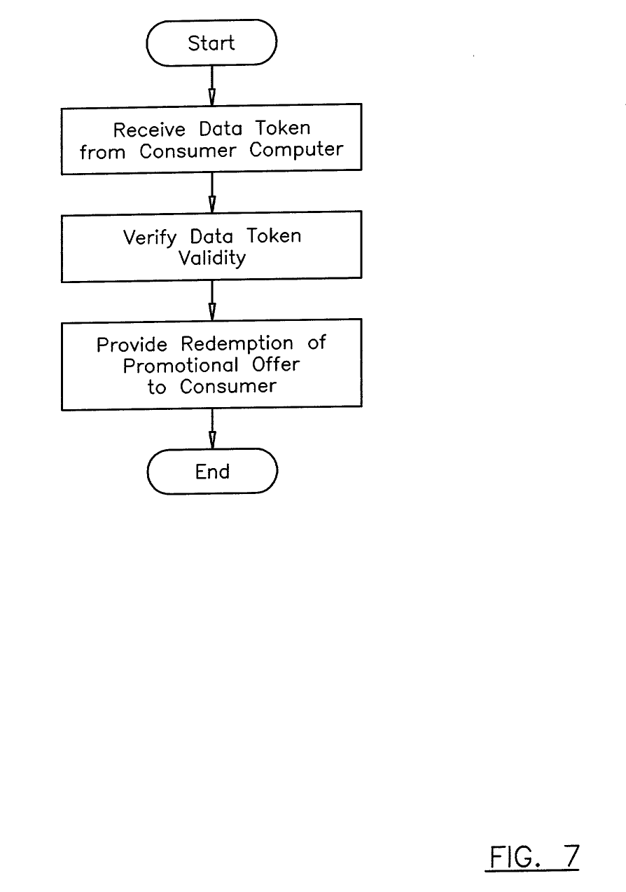

FIG. 8 is a flowchart illustrating the logging of file data information upon the computer system when the viewer selects an object.

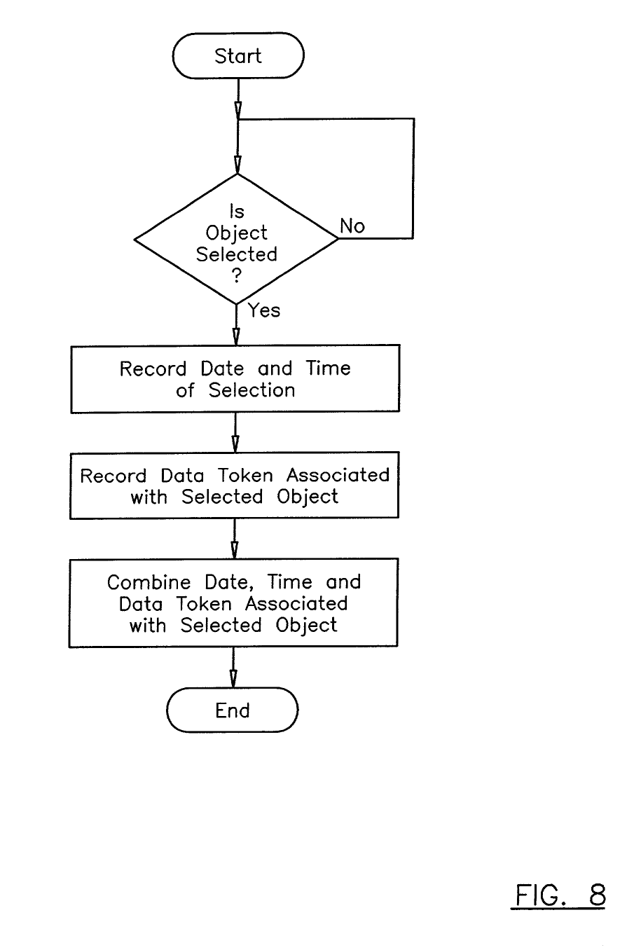

FIG. 9 is a front view of a television displaying a commercial with an object within the upper left portion for the viewer to select for an online discount.

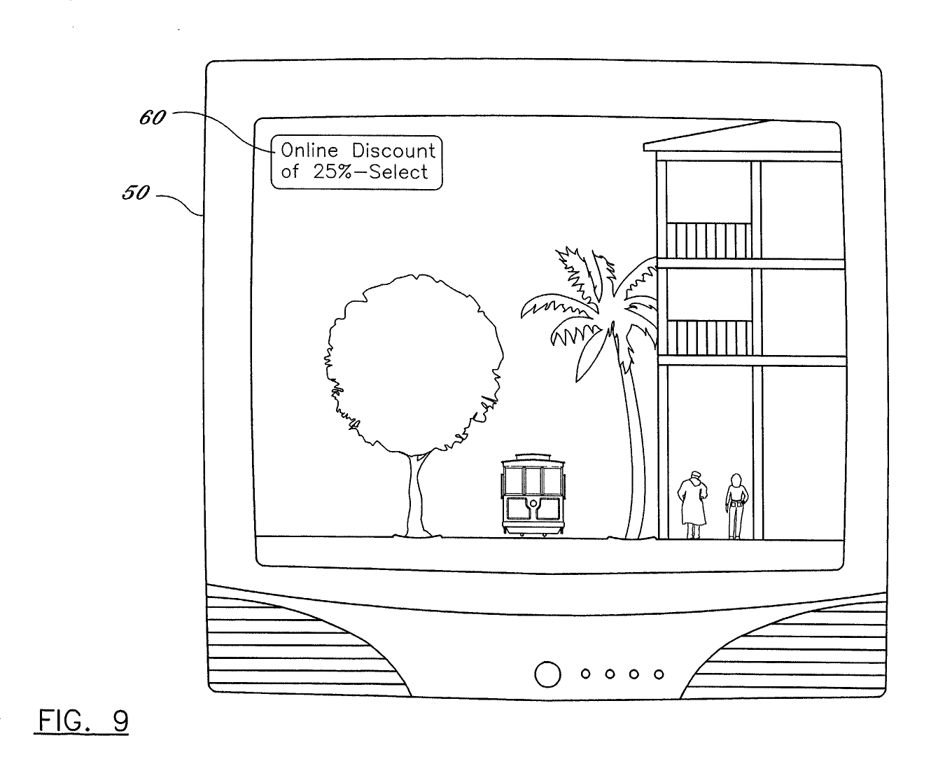

FIG. 10 is a box diagram illustrating the overall communication sequence of the present invention between the control center, broadcast station and the consumer computer system.

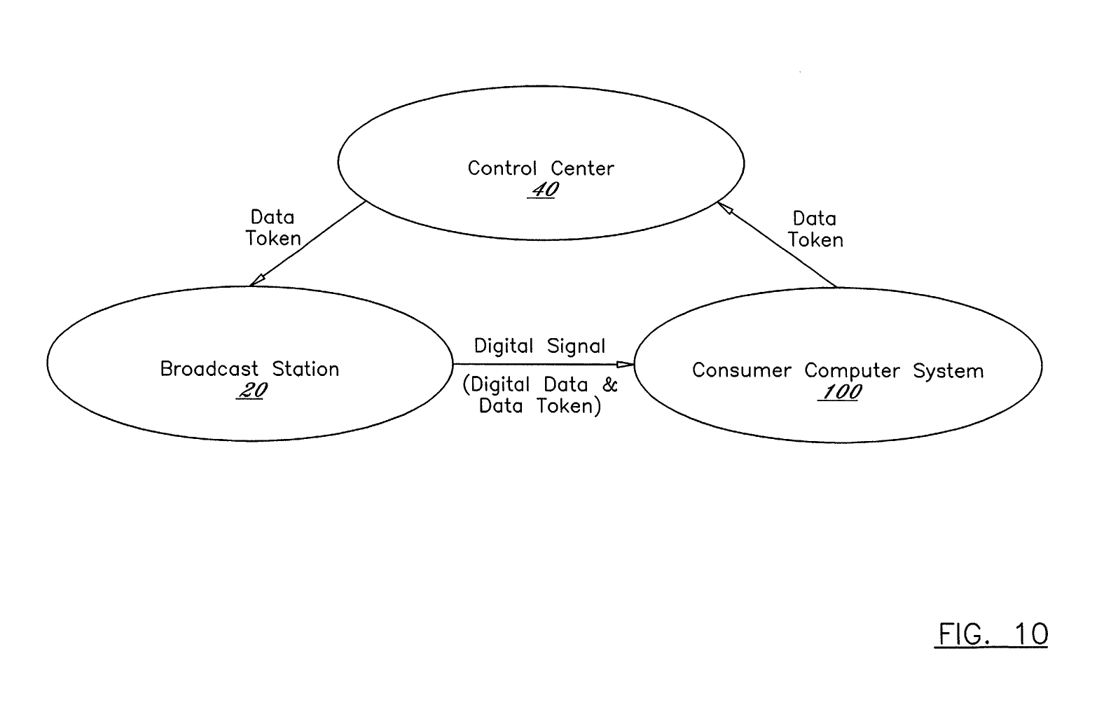

### DESCRIPTION OF THE PREFERRED EMBODIMENT

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital video discs), and computer instruction signals embodied in a transmission medium (with or without a carrier wave upon which the signals are modulated). For example, the transmission medium may include a communications network, such as the Internet.

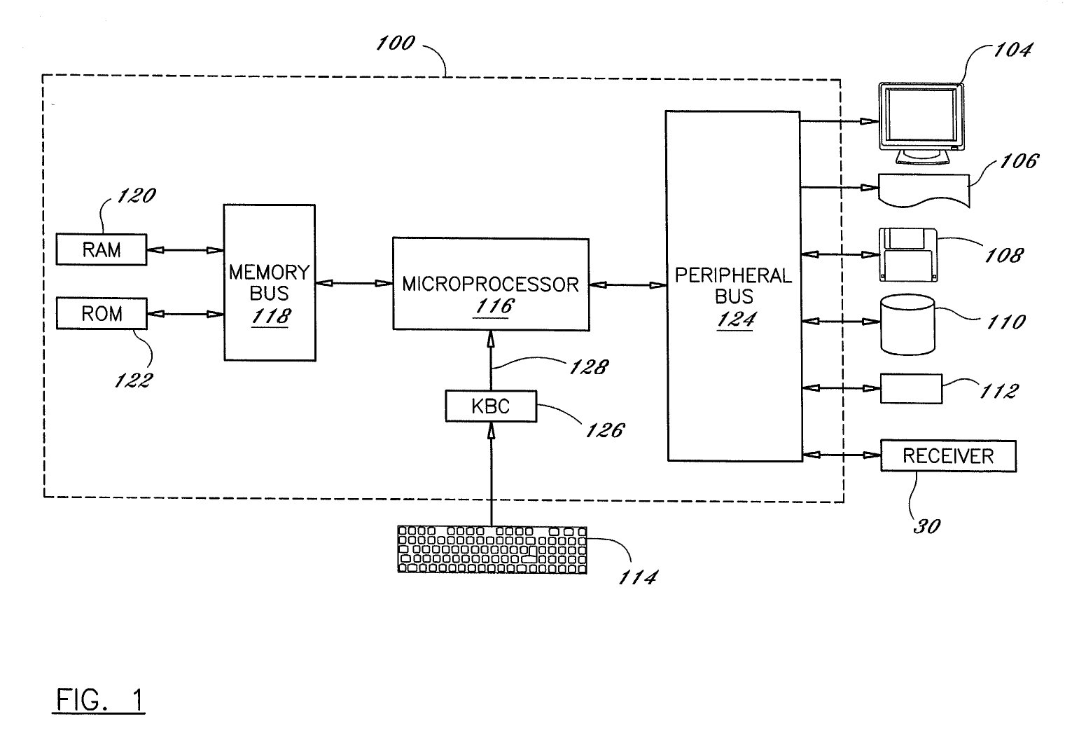

FIG. 1 is a block diagram of an exemplary computer system 100 for practicing the various aspects of the present invention. Computer system 100 includes a display screen (or monitor) 104, a printer 106, a floppy disk drive 108, a hard disk drive 110, a network interface 112, and a keyboard 114. Computer system 100 includes a microprocessor 116, a memory bus 118, random access memory (RAM) 120, read only memory (ROM) 122, a peripheral bus 124, and a keyboard controller 126. Computer system 100 can be a personal computer (such as an APPLE computer, an IBM computer, or one of the compatibles thereof), a workstation computer (such as a SUN MICROSYSTEMS or HEWLETT-PACKARD workstation), or various other types of computers.

The microprocessor 116 is a general purpose digital processor which controls the operation of the computer system 100. Microprocessor 116 can be a single-chip processor or implemented with multiple components. Using instructions retrieved from memory, microprocessor 116 controls the reception and manipulations of input data and the output and display of data on output devices.

Memory bus 118 is used by microprocessor 116 to access RAM 120 and ROM 122. RAM 120 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output and storage devices used by the computer system 100. In the described embodiment(s), these devices include a display screen 104, a printer device 106, a floppy disk drive 108, a hard disk drive 110, and a network interface 112. A keyboard controller 126 is used to receive input from the keyboard 114 and send decoded symbols for each pressed key to microprocessor 116 over bus 128.

The display screen 104 is an output device that displays images of data provided by the microprocessor 116 via the peripheral bus 124 or provided by other components in the computer system 100. The printer device 106 when operating as a printer provides an image on a sheet of paper or a similar surface. Other output devices such as a plotter, typesetter, etc. can be utilized in place of, or in addition to, the printer device 106.

The floppy disk drive 108 and the hard disk drive 110 can be utilized to store various types of data. The floppy disk drive 108 facilitates transporting such data to other computer systems, and the hard disk drive 110 permits fast access to large amounts of stored data.

The microprocessor 116 together with an operating system operate to execute computer code and produce and use data. The computer code and data may reside on RAM 120, ROM 122, or hard disk drive 120. The computer code and data could also reside on a removable program medium and loaded or installed onto computer system 100 when needed. Removable program mediums include, for example, CD-ROM, PC-CARD, floppy disk and magnetic tape.

The network interface circuit 112 is utilized to send and receive data over a network connected to other computer systems. An interface card or similar device and appropriate software implemented by microprocessor 116 can be utilized to connect the computer system 100 to an existing network and transfer data according to standard protocols.

The keyboard 114 is used by a user to input commands and other instructions to the computer system 100. Other types of user input devices can also be used in conjunction with the present invention. For example, pointing devices such as a computer mouse, a track ball, a stylus, or a tablet to manipulate a pointer on a screen of the computer system 100.

The present invention can also be embodied as computer readable code on a computer readable medium. The computer readable medium is any data storage device that can store data which can be thereafter be read by a computer system. Examples of the computer readable medium include read-only memory, random-access memory, magnetic data storage devices such as diskettes, and optical data storage devices such as CD-ROMs. The computer readable medium can also be distributed over a network coupled computer systems so that the computer readable code is stored and executed in a distributed fashion.

Televisions 50 and other electronic devices are now being constructed to receive digital signals directly and that allows for manipulation of data received from a digital signal. Televisions 50 with these capabilities are similar in construction and functionality to the conventional computer system 100 as shown in FIG. 1 of the drawings. A receiver box connected to the television 50 may also serve as the computer system 100 when receiving the digital signal and selecting the various objects 60 displayed upon the display screen 104 or the television 50. Various other devices are capable of receiving digital signals and communicating with computer systems 100 via the Internet 12 as can be appreciated.

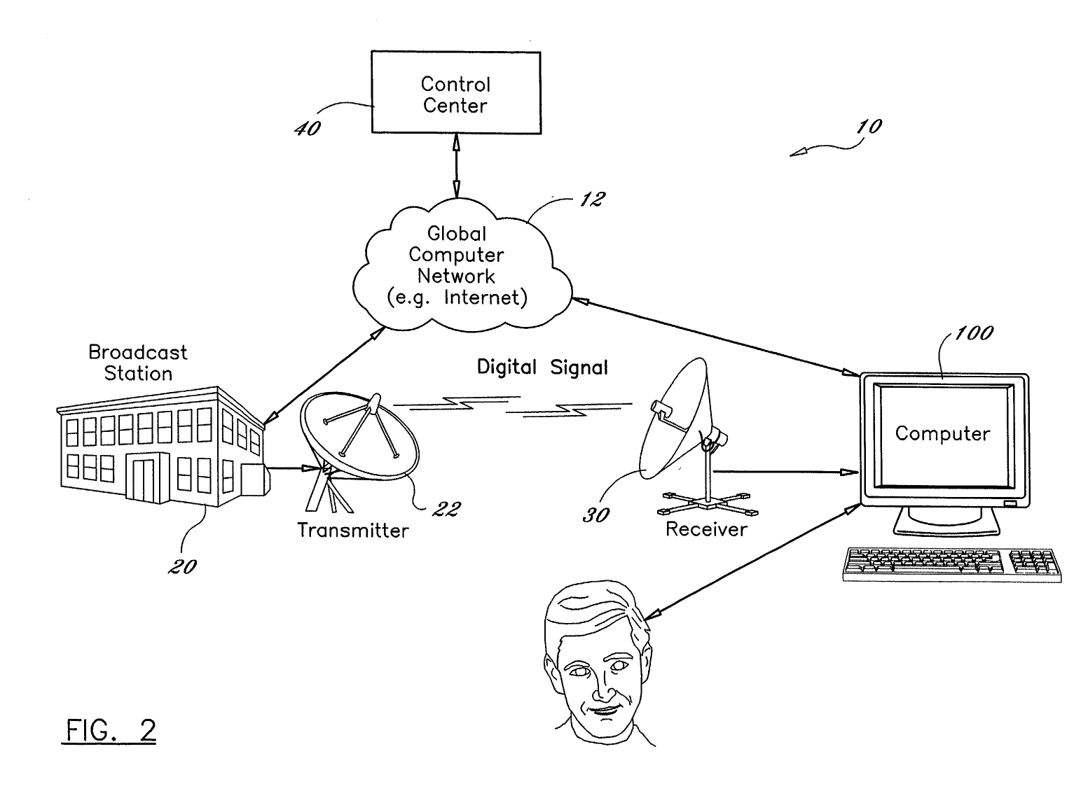

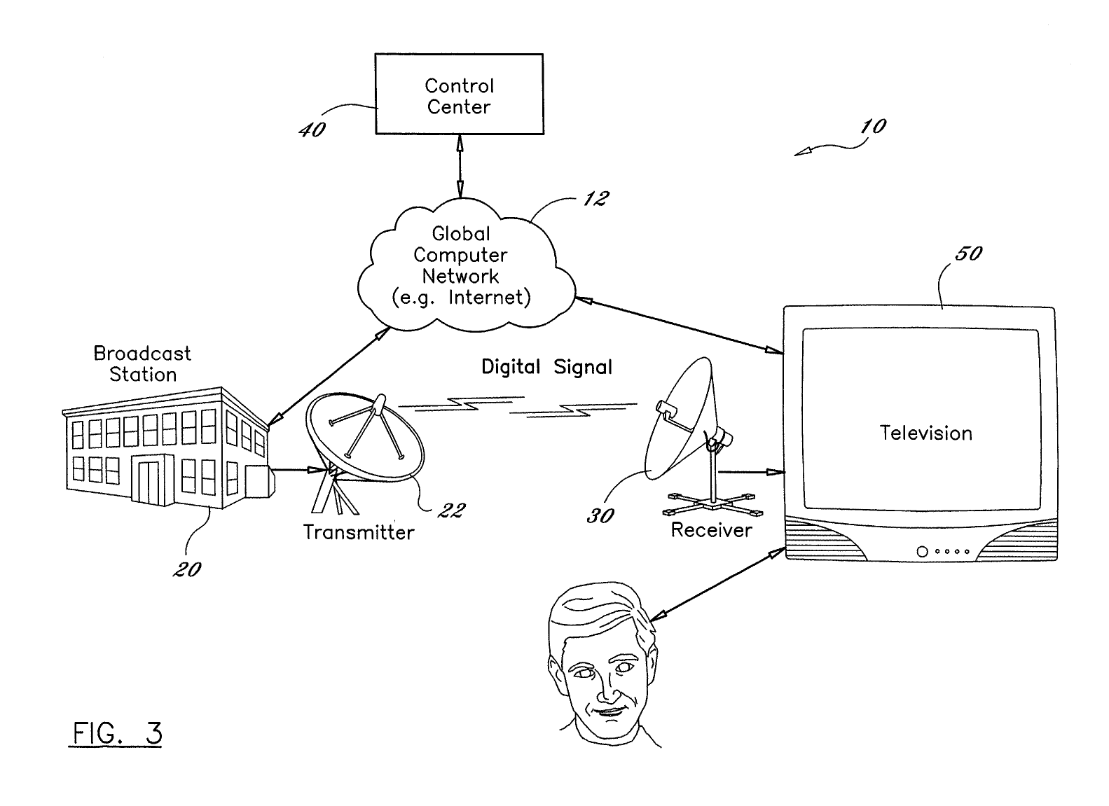

As shown in FIGS. 2 and 3 of the drawings, the Internet 12 is comprised of a “global computer network”. A plurality of computer systems 100 around the world are in communication with one another via this global computer network through various telecommunication systems. The present invention utilizes the Internet 12, however it can be appreciated that as future technologies are created that various aspects of the invention may be practiced with these improved technologies.

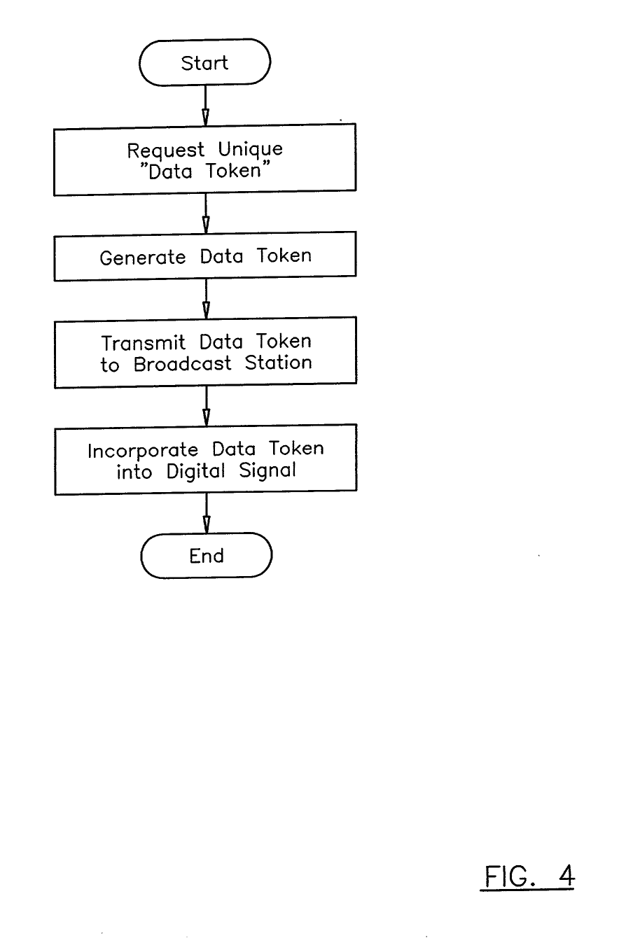

The control center 40, the broadcast station 20 and the consumer computer system 100 are all in communication with one another via the Internet 12. As shown in FIG. 4 of the drawings, when the broadcast station 20 desires to transmit a data file containing various types of information, the broadcast station 20 or other third-party entity transmits a “request” to the control center 40 for a unique “digital token”. The digital token is merely a unique data file that has a unique serial number or other identifying characteristic which allows the control center 40 to determine which promotional offer is being accepted by a consumer. When requesting the digital token, the broadcast station 20 may be required to enter various types of information regarding themselves, the digital broadcast and the promotional offer to be associated with the digital token. Once the control center 40 has received the request for a digital token, the control center 40 then generates a unique digital token and transmits this unique digital token to the broadcast station via the Internet. As further shown in FIG. 4 of the drawings, upon receiving the digital token, the broadcast station 20 then incorporates the digital token into the digital signal to be transmitted to consumers and viewers.

An alternative system of generating and supplying digital tokens to be utilized within a digital signal involves utilizing a third-party such as an advertising agency or similar entity. This third party could purchase individual or bulk digital tokens to be generated by the control center 40 and then distributed to a broadcast station 20 individually to be added to a digital signal or directly added to a digital program that is later provided to a broadcast station 20 to be transmitted at a later date.

The following patents are considered relevant to incorporating data files such as the above-stated data token into a digital signal of the present invention and are incorporated herein by reference: U.S. Pat. No. 5,534,942 to Beyers, Jr. et al. and U.S. Pat. No. 5,969,770 to Horton. The aforementioned patents which form a part of this disclosure, may be applied in known manner by those skilled in the art in order to practice various embodiments of the present invention.

As further shown in FIG. 2 of the drawings, the broadcast station 20 transmits a digital signal containing the digital data and the digital token. The transmission of this digital signal may be via “over-the-air”, cable, Internet 12, or other communication means available. Over-the-air transmissions may occur by conventional signal transmission or by satellite. If transmitted via over-the-air a transmitter 22 broadcasts the digital signal to individuals within a specific broadcast area. If using satellite technology, the digital signal is transmitted to a satellite, which resends the digital signal to the surface of the earth to be received.

Regardless of the method of transmitting the digital signal, a receiver 30 is utilized by viewers to receive the digital signal. The receiver 30 may be comprised of various well-known technologies such as but not limited to antennas, satellite dishes, tuner cards for personal computers 100, or receiver boxes for cable. The receiver 30 converts the digital signal to a format viewable upon a display screen 104 of a personal computer, personal digital assistant, or a television 50 as shown in FIGS. 1 through 3 of the drawings.

The digital signal includes various multimedia content such as but not limited to video, audio, objects 60 and data tokens. Each of the objects 60 has a corresponding data token that represents the particular offer or promotion being offered with the selection of the particular object 60. The object 60 may be comprised of a graphical element (moving or non-moving) and/or textual representing a promotional item. The viewer desiring to participate within the promotional offer may “select” the object 60 via the computer system 100 by utilizing a computer mouse or similar device.

The viewer desiring to participate within the promotional offer may also “select” the object 60 utilizing a remote control device that is in communication with their television 50 or cable box. More particularly, the remote control device utilizes a transceiver system for sending and receiving communications with respect to the television 50 or cable box. The remote control device may be utilized to control the operation of the electronic devices or specifically designed for selecting the objects 60 displayed. It can also be appreciated that multiple remote control devices may be utilized within the present invention for allowing multiple individuals to select desired objects 60 when displayed.

The remote control device is preferably constructed to include a memory unit that is capable of receiving, storing and transmitting one or more data tokens as received. When a specific button is selected upon the remote control device, a selection signal is transmitted to the television 50 or cable box indicating that the user desires to download the data token associated with a currently displayed object 60. The television 50 or cable box then transmits the data token to the remote control device which is then stored within the memory unit. The user may then transfer the data token to a computer for uploading to the control center 40. Alternatively, the data token may be transferred to another remote control device for use by another individual.

As shown in FIGS. 2 and 3 of the drawings, the control center 40 is in communication with the broadcast station 20 and the viewer computer systems 100 via the Internet 12. The control center 40 is comprised of one or more computers that are capable of storing data regarding programming from the broadcast stations 20 and matching this programming data with the file data received from viewer computer systems 100.

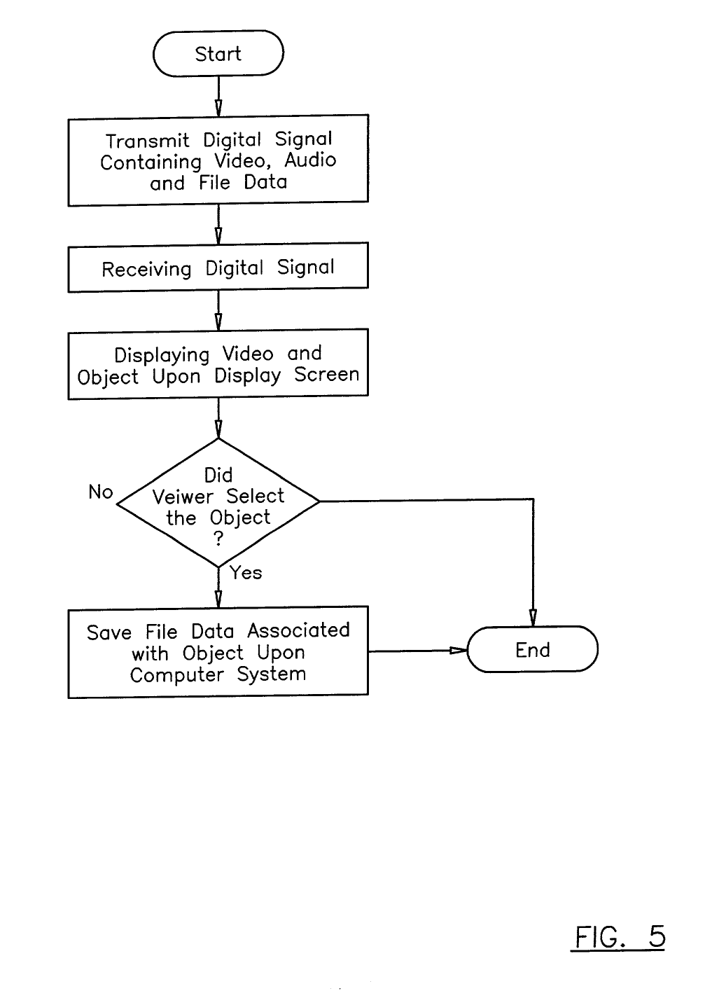

As shown in FIG. 5 of the drawings, the broadcast station 20 transmits the digital signal containing various multimedia data, objects 60 and data token associated with the objects 60. Software and other common tools are utilized to add the objects 60 and data tokens to the multimedia digital signal as required. The receiver 30 receives this digital signal and converts the digital signal to a form that is transmitted to a display screen 104 of a computer system 100 or a television 50. The computer system 100 and/or television 50 then displays the digital broadcast transmitted from the broadcast station 20. The following patents are considered relevant to the data transfer, reception and display of the present invention and are incorporated herein by reference: U.S. Pat. No. 5,534,942 to Beyers, Jr. et al. and U.S. Pat. No. 5,969,770 to Horton. The aforementioned patents, some of which are mentioned elsewhere in this disclosure, and which form a part of this disclosure, may be applied in known manner by those skilled in the art in order to practice various embodiments of the present invention.

When an object 60 is displayed, the individual viewing the digital television broadcast has the option of “selecting” this object with a pointer, remote control device or similar means. When the individual selects an object 60, the data token associated with the object is logged upon the computer system 100 or television 50, and retained with other saved object information that have been selected. If a remote control device is utilized, the data token is preferably transmitted to the remote control device via a transceiver system for storage upon the remote control device. The date, time, broadcast station identification, program identification and other important data are preferably logged in addition to the data token associated with the object 60 to assist the control center 40 in determining important marketing statistics and information regarding viewers of the television program and commercials. If the individual does not select a displayed object 60, there is no information logged upon the computer system 100.

When the computer system 100 is online with the Internet, the computer system 100 then uploads the logged events regarding the selection of specified objects and the corresponding data tokens for redemption. This information is verified and stored within a database within the control center 40 for future market research. The individual then is able to redeem their discount or other promotional item for selecting the object 60 displayed during the television broadcast/transmission. Important marketing information can be received from monitoring when the consumer selects the object 60.

As to a further discussion of the manner of usage and operation of the present invention, the same should be apparent from the above description. Accordingly, no further discussion relating to the manner of usage and operation will be provided.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. Additionally, the above disclosure is not intended to limit the invention. The scope of the invention is defined by the appended claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Index of Elements for Internet-Based Digital Promotion System-PAGE 1

| | | | |
|---|---|---|---|
| | ENVIRONMENTAL ELEMENTS | 40. | Control Center |
| | | 41. | |
| | | 42. | |
| | | 43. | |
| | | 44. | |
| | | 45. | |
| | | 46. | |
| | | 47. | |
| | | 48. | |
| | | 49. | |
| 10. | Internet-Based Digital Promotion System | 50. | Television |
| 11. | | 51. | |
| 12. | Internet | 52. | |
| 13. | | 53. | |
| 14. | | 54. | |
| 15. | | 55. | |
| 16. | | 56. | |
| 17. | | 57. | |
| 18. | | 58. | |
| 19. | | 59. | |
| 20. | Broadcast Station | 60. | Object |
| 21. | | 61. | |
| 22. | Transmitter | 62. | |
| 23. | | 63. | |
| 24. | | 64. | |
| 25. | | 65. | |
| 26. | | 66. | |
| 27. | | 67. | |
| 28. | | 68. | |
| 29. | | 69. | |
| 30. | Receiver | 70. | |
| 31. | | 71. | |
| 32. | | 72. | |
| 33. | | 73. | |
| 34. | | 74. | |
| 35. | | 75. | |
| 36. | | 76. | |
| 37. | | 77. | |
| 38. | | 78. | |
| 39. | | 79. | |
| 100. | Computer System | | |
| 101. | | | |
| 102. | | | |
| 103. | | | |
| 104. | Display Screen | | |
| 105. | | | |
| 106. | Printer | | |
| 107. | | | |
| 108. | Floppy Disk Drive | | |
| 109. | | | |
| 110. | Hard Disk Drive | | |
| 111. | | | |
| 112. | Network Interface | | |
| 113. | | | |
| 114. | Keyboard | | |
| 115. | | | |
| 116. | Microprocessor | | |
| 117. | | | |
| 118. | Memory Bus | | |
| 119. | | | |
| 120. | RAM | | |
| 121. | | | |
| 122. | ROM | | |
| 123. | | | |
| 124. | Peripheral Bus | | |
| 125. | | | |
| 126. | Keyboard Controller | | |
| 127. | | | |
| 128. | Bus | | |
| 129. | | | |
| 130. | | | |
| 131. | | | |
| 132. | | | |
| 133. | | | |
| 134. | | | |
| 135. | | | |
| 136. | | | |
| 137. | | | |
| 138. | | | |
| 139. | | | |

We claim:

1. An Internet-based digital promotion system, comprising:
a viewing unit;
a transmission station which transmits said digital signal to said viewing unit, wherein said digital signal is comprised of multimedia content, an object, and a data token associated with said object, wherein said viewing unit receives and displays said digital signal and said object; and
a control center in communication with said viewing unit via a global computer network for transferring said data token from said viewing unit to said control center for redemption.

2. The Internet-based digital promotion system of claim 1, wherein said digital token is comprised of a unique identifier for a specific object.

3. The Internet-based digital promotion system of claim 1, wherein said control center generates and transfers said data token to said transmission station upon receiving a request from said transmission station and wherein said transmission station incorporates said data token within said digital signal to be associated with said object.

4. The Internet-based digital promotion system of claim 1, wherein said control center generates and transfers a plurality of data tokens to said transmission station and wherein said transmission station incorporates each of said plurality of data tokens within said digital signal to be associated with a respective object.

5. The Internet-based digital promotion system of claim 1, wherein when a user selects said object being displayed upon said viewing unit said data token is stored upon said viewing unit, and wherein when said user does not select said object being displayed upon said viewing unit said data token is not stored upon said viewing unit.

6. The Internet-based digital promotion system of claim 5, wherein said viewing unit is comprised of a display unit receiving said digital signal and a remote control device in communication with said display unit, wherein said remote control device is capable of receiving, storing and transmitting one or more of said data tokens.

7. The Internet-based digital promotion system of claim 6, wherein said remote control device is capable of transferring said data token to a second remote control device.

8. The Internet-based digital promotion system of claim 6, wherein said remote control device is capable of transferring said data token directly to said control center.

9. The Internet-based digital promotion system of claim 6, wherein said remote control device is capable of transferring said data toke to said control center via a computer unit.

10. The Internet-based digital promotion system of claim 6, wherein said display unit is comprised of a cable unit in communication with said remote control device, and a television unit in communication with said cable unit.

11. The Internet-based digital promotion system of claim 1, wherein said viewing unit is comprised of a computer unit.

12. The Internet-based digital promotion system of claim 1, wherein said control center receives supplemental data relating to an event of selecting said object.

13. A method of providing an Internet-based digital promotion, comprising the steps of:
(a) providing a control center, a viewing unit in communication with said control center, and a transmission station in communication with said control center and said viewing unit;
(b) requesting a data token from said control center by said transmission station;
(c) generating a unique data token by said control center;
(d) transmitting said data token to said transmission station;
(e) combining said data token into a digital signal;
(f) transmitting said digital signal comprised of multimedia content, an object, and said data token associated with said object;
(g) receiving said digital signal by said viewing unit;
(h) selecting said object; and
(i) logging said selected object and corresponding said data token upon said viewing unit.

14. The method of providing an Internet-based digital promotion of claim 13, including the step of:
(j) transmitting said logged object and data token to said control center via a global computer network.

15. The method of providing an Internet-based digital promotion of claim 13, wherein step (i) further includes logging of event data comprised of date and time of selecting said object.

16. The method of providing an Internet-based digital promotion of claim 14, including the step of:
(k) verifying said data token; and
(l) redeeming of a promotional offer relating to said selected object and said data token.

17. A method of providing an Internet-based digital promotion, comprising the steps of:
(a) providing a control center, a viewing unit in communication with said control center, a remote control unit in communication with said viewing unit, and a transmission station in communication with said control center and said viewing unit;
(b) requesting a data token from said control center by said transmission station;
(c) generating a unique data token by said control center;
(d) transmitting said data token to said transmission station;
(e) combining said data token into a digital signal;
(f) transmitting said digital signal comprised of multimedia content, an object, and said data token associated with said object;
(g) receiving said digital signal by said viewing unit;
(h) selecting said object utilizing said remote control unit; and
(i) logging said selected object and corresponding said data token upon said viewing unit and transmitting said data toke to said remote control unit.

18. The method of providing an Internet-based digital promotion of claim 17, including the step of:
(j) transmitting said data token to said control center via a global computer network.

19. The method of providing an Internet-based digital promotion of claim 17, wherein step (i) further includes logging of event data comprised of date and time of selecting said object.

20. The method of providing an Internet-based digital promotion of claim 18, including the step of:
(k) verifying said data token; and
(l) redeeming of a promotional offer relating to said selected object and said data token.
